(19) United States
(12) Patent Application Publication
(10) Pub. No.: US 2026/0072934 A1
(43) Pub. Date: Mar. 12, 2026

(54) RESPONSE FILTER TO PREVENT HALLUCINATIONS IN A LARGE LANGUAGE MODEL

(71) Applicant: The Toronto-Dominion Bank, Toronto (CA)

(72) Inventor: Seyed Pedram Mirmiran, Guelph (CA)

(73) Assignee: The Toronto-Dominion Bank, Toronto (CA)

(21) Appl. No.: 18/829,890

(22) Filed: Sep. 10, 2024

(51) Int. Cl. G06F 16/25; G06F 8/60

(52) U.S. Cl. CPC G06F 16/258; G06F 8/60

(57) ABSTRACT

An example operation may include one or more of executing an artificial intelligence (AI) model on a query via a software application to generate a formatted data structure, executing a filter on the formatted data structure and conditions of the formatted data structure to determine that the formatted data structure does not satisfy a condition from among the conditions, identifying a prompt that corresponds to the condition, executing the AI model on the formatted data structure and the prompt to generate a modified formatted data structure, executing the filter on the modified formatted data structure and the conditions associated with the formatted data structure to determine that the modified formatted data structure matches the conditions, and in response, deploying a software system via a host platform and executing the modified formatted data structure as part of the software system.

### BACKGROUND

A configuration file, also referred to as a config file, is a file that defines settings and features for configuring systems such as operating systems, software applications, infrastructure components, and the like. For example, a configuration file can be used to customize how a software application works such as color schemes, default directory for saving files, messaging settings, application programming interfaces (APIs), and the like, without having to change the source code of the software application. A configuration file is often a simple text file written in a common configuration language for extensible markup, object notation, or the like, and may include a list of settings with each setting configuring a setting of a target system. Content within a configuration file is often formatted according to specific requirements such as requirements of an organization, requirements of a software program, or the like.

### SUMMARY

One example embodiment provides an apparatus that includes a memory to store an artificial intelligence (AI) model, and a processor, wherein the processor may one or more of store a set of configuration files of a software system within a database, receive a query associated with the software system via a graphical user interface (GUI) of a software application, execute the AI model on the query and the set of configuration files to generate a configuration file that matches the query, determine a set of constraints associated with at least one of the software system and the configuration file, determine that the configuration file matches the set of constraints based on execution of a filter on the configuration file and the set of constraints, and in response to a determination that the configuration file matches the set of constraints, deploy the software system based on the configuration file.

Another example embodiment provides a method that includes one or more of storing a set of configuration files of a software system within a database, receiving a query associated with the software system via a graphical user interface (GUI) of a software application, executing an artificial intelligence (AI) model on the query and the set of configuration files to generate a configuration file that matches the query, determining a set of constraints associated with at least one of the software system and the configuration file, determining that the configuration file matches the set of constraints based on execution of a filter on the configuration file and the set of constraints, and in response to a determination that the configuration file matches the set of constraints, deploying the software system based on the configuration file.

A further example embodiment provides a computer readable storage medium comprising instructions, that when read by a processor, cause the processor to perform one or more of storing a set of configuration files of a software system within a database, receiving a query associated with the software system via a graphical user interface (GUI) of a software application, executing an artificial intelligence (AI) model on the query and the set of configuration files to generate a configuration file that matches the query, determining a set of constraints associated with at least one of the software system and the configuration file, determining that the configuration file matches the set of constraints based on execution of a filter on the configuration file and the set of constraints, and in response to a determination that the configuration file matches the set of constraints, deploying the software system based on the configuration file.

One example embodiment provides an apparatus that includes a memory to store an artificial intelligence (AI) model, and a processor, wherein the processor may one or more of execute the AI model on a query via a software application to generate a formatted data structure, execute a filter on the formatted data structure and conditions of the formatted data structure to determine that the formatted data structure does not match a condition from among the conditions, identify a prompt that corresponds to the condition, execute the AI model on the formatted data structure and the prompt to generate a modified formatted data structure, execute the filter on the modified formatted data structure and the conditions associated with the formatted data structure to determine that the modified formatted data structure matches the conditions, and in response, deploy a software system via a host platform and executing the modified formatted data structure as part of the software system.

Another example embodiment provides a method that includes one or more of executing an artificial intelligence (AI) model on a query via a software application to generate a formatted data structure, executing a filter on the formatted data structure and conditions of the formatted data structure to determine that the formatted data structure does not satisfy a condition from among the conditions, identifying a prompt that corresponds to the condition, executing the AI model on the formatted data structure and the prompt to generate a modified formatted data structure, executing the filter on the modified formatted data structure and the conditions associated with the formatted data structure to determine that the modified formatted data structure matches the conditions, and in response, deploying a software system via a host platform and executing the modified formatted data structure as part of the software system.

A further example embodiment provides a computer readable storage medium comprising instructions, that when read by a processor, cause the processor to perform one or more of executing an artificial intelligence (AI) model on a query via a software application to generate a formatted data structure, executing a filter on the formatted data structure and conditions of the formatted data structure to determine that the formatted data structure does not satisfy a condition from among the conditions, identifying a prompt that corresponds to the condition, executing the AI model on the formatted data structure and the prompt to generate a modified formatted data structure, executing the filter on the modified formatted data structure and the conditions associated with the formatted data structure to determine that the modified formatted data structure matches the conditions, and in response, deploying a software system via a host platform and executing the modified formatted data structure as part of the software system.

### BRIEF DESCRIPTION OF DRAWINGS

FIGS. 1A-1C are diagrams illustrating an artificial intelligence (AI) system for generating and validating a configuration file according to examples and features of the instant solution.

FIG. 2A is a system diagram illustrating integration of an AI model into any decision point according to the examples and features of the instant solution.

FIG. 2B is a diagram illustrating a process for developing an AI model that supports AI-assisted computer decision points according to the examples and features of the instant solution.

FIG. 2C is a diagram illustrating a process for utilizing an AI model that supports AI-assisted computer decision points according to examples and features of the instant solution.

FIGS. 3A-3C are diagrams illustrating a process of validating a configuration file using an AI system according to examples and features of the instant solution.

FIGS. 4A-4B are diagrams illustrating a process of generating prompts for modifying a configuration file according to examples and features of the instant solution.

FIG. 5 is a diagram illustrating a process of deploying a software system and configuring the software system using a configuration file according to examples and features of the instant solution.

FIGS. 6A-6B are diagrams illustrating a method of generating and validating a configuration file according to examples and features of the instant solution.

FIGS. 7A-7B are diagrams illustrating a method of generating and modifying a formatted data structure according to examples and features of the instant solution.

FIG. 8 is a system diagram illustrating a computing environment according to the instant solution's example features, structures, or characteristics.

### DETAILED DESCRIPTION

The examples and features of the instant solution are directed to an artificial intelligence (AI) system that can generate a configuration file using existing configuration files and validate a format / content within the configuration file. The AI system may include at least one AI model that is configured to generate a configuration file in response to a query such as a natural language input with a description of a desired configuration file. The at least one AI model may be a large language model (LLM) or other type of generative AI model that can generate new content from existing content. Here, the at least one AI model may ingest existing configuration files from a database. The existing configuration files may be written in a common configuration language for extensible markup, object notation, or the like.

The configuration file generated by the at least one AI model may be validated/checked to ensure that the configuration file satisfies constraints or other conditions such as those imposed by an organization, those imposed by legal requirements, those imposed by an application which is going to access the configuration file, and the like. Here, a filter may execute on the configuration file and the constraints to determine whether the configuration file matches the constraints. Constraints may include formatting requirements, ordering of instruction requirements, variable types, and the like.

When the filter detects that a constraint is not met by the generated configuration file, the filter can generate a prompt based on the constraint and transfer the prompt to the at least one AI model along with the configuration file. Here, the at least one AI model may re-generate the configuration file based on the prompt. The filter may perform a similar validation on the re-generated configuration file. The same process/loop may be iteratively repeated until the configuration file meets/matches all of the constraints. When the configuration file is fully validated, the configuration file may be used to configure a software system such as a software application, an API, an operating system, and the like. As another example, the configuration file may be used to configure infrastructure such as a server, a cluster, or the like.

The instant solution involves the challenge of generating and validating configuration files for complex software systems, which often involve numerous constraints related to formatting, organizational standards, and system-specific requirements. Traditionally, ensuring that a configuration file meets all necessary conditions and constraints is time-consuming and error-prone, requiring manual intervention and repeated iterations. This problem is exacerbated by the increasing complexity of modern software environments, where even minor deviations from prescribed standards can lead to system failures, security vulnerabilities, or degraded performance. The instant solution aims to automate this process using an AI-driven system, reducing the need for manual oversight while ensuring that configuration files are both accurate and compliant with all relevant requirements.

The instant solution provides an AI-driven system that automates the generation and validation of configuration files for complex software systems. This system integrates a pre-trained AI model, fine-tuned using proprietary data, including existing configuration files, documentation, and organizational standards. Upon receiving a query via a graphical user interface (GUI), the AI model generates a configuration file tailored to the specified requirements. The generated file is then subjected to a filtering process that checks for compliance with predefined constraints, such as formatting standards, system requirements, and organizational policies. If the file fails to meet these constraints, the system modifies and revalidates it using dynamic prompts until it fully complies. The validated configuration file can then be deployed to configure a software system, ensuring accurate and efficient implementation of the desired settings. This solution reduces the risk of errors, enhances compliance with standards, and accelerates the deployment process for software systems.

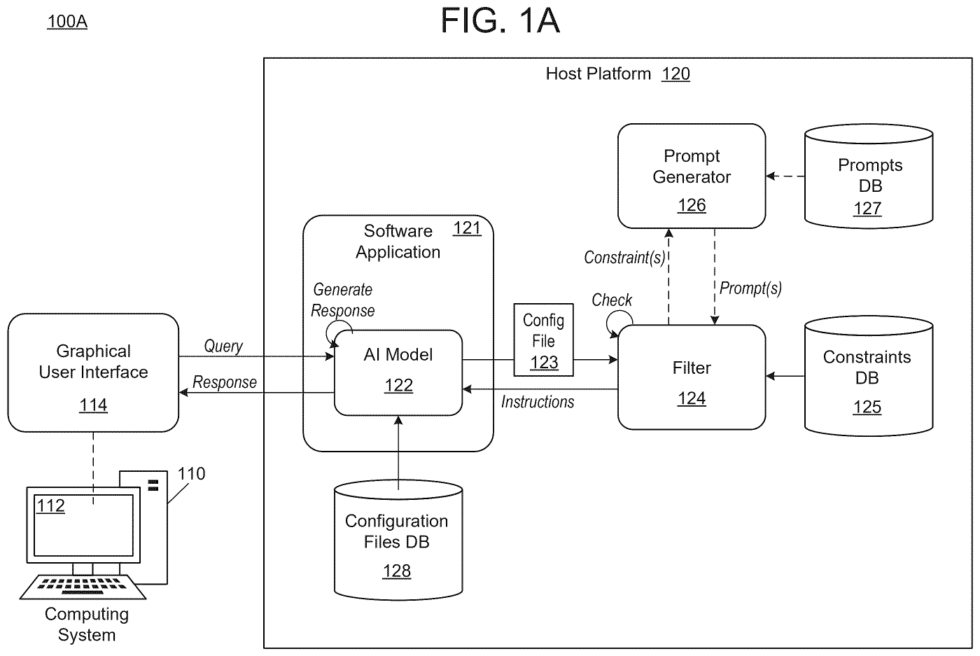

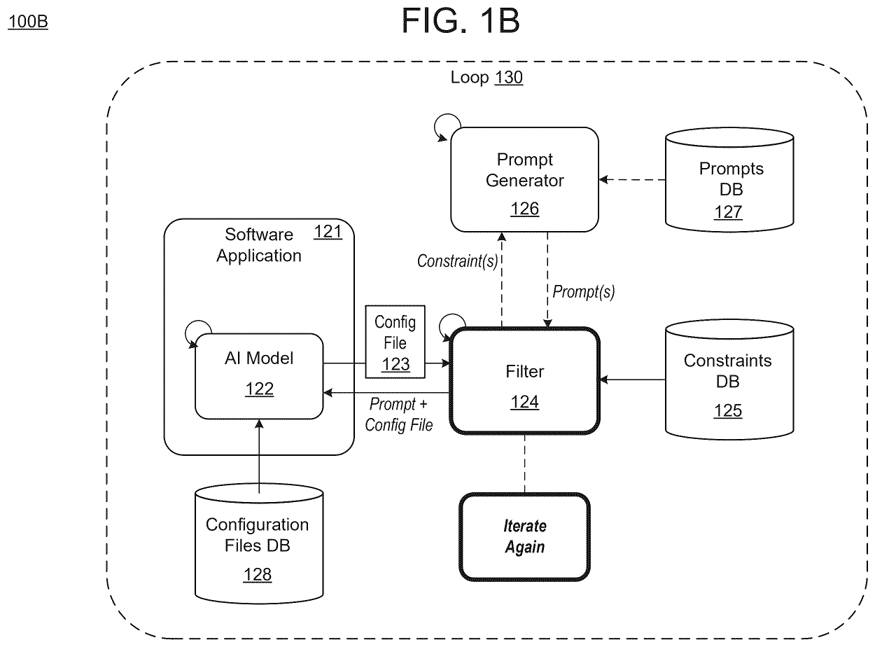

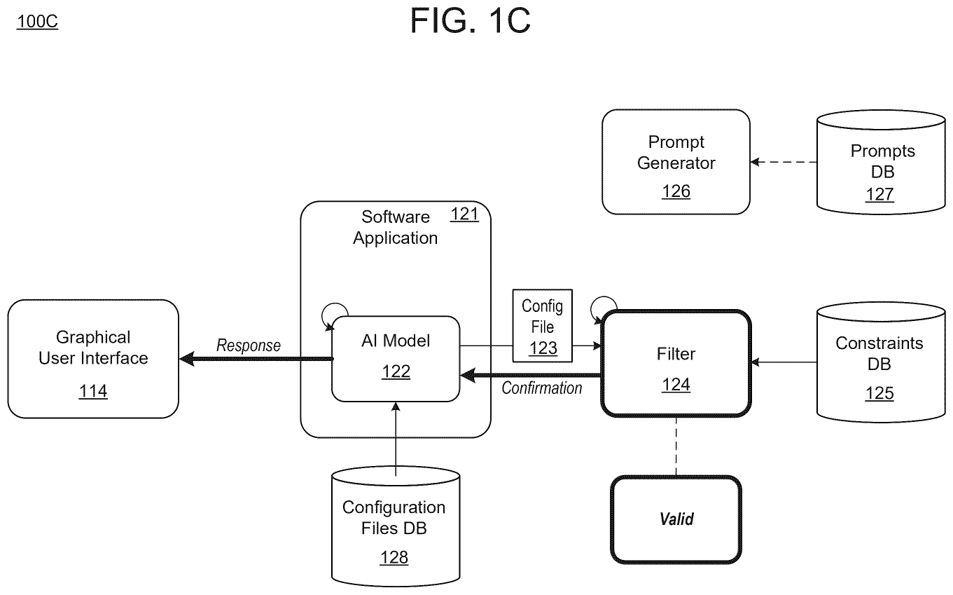

FIG. 1A illustrates an AI system 100A for generating and validating a configuration file according to examples and features of the instant solution. Referring to FIG. 1A, a host platform 120 may host the AI system which includes a software application 121, a filter 124 and a prompt generator 126. The software application also includes at least one AI model 122 that can be used to generate a configuration file based on configuration files, best practices, standards, and other documents, which are stored within a configuration files database 128. The host platform 120 may be a web server, a cloud platform, a local machine, or the like, with at least one processor for executing the AI system.

In this example, a computing device 110 may connect to the software application 121 by establishing a connection with the host platform 120 over a network such as the Internet or the like. The computing device 110 may access the software application through a browser, a progressive web application, a mobile application, or the like. As an example, a user may enter a web address of the software application 121 into a browser installed on the computing device 110. As another example, a front-end of the software application 121 may be installed on the computing device 110 while a back-end of the software application 121 is hosted by the host platform 120.

The software application 121 may output a graphical user interface 114 (e.g., GUI 114) on a display screen 112 of the computing device 110. Here, a user may enter commands via the GUI 114 to query the software application 121 for a configuration file. The query may include a natural language input that provides a description of the configuration file. For example, the query may state, “Please generate a configuration file for configuring Software ABC to communicate with Software DCF.” In response, the AI model 122 may generate a configuration file 123 that configures an API that enables communication between Software ABC and Software DCF using existing configuration files stored in the configuration files database 128.

According to various examples and features of the instant solution, the configuration file 123 generated by the AI model 122 may be validated by the filter 124. Organizations often provide best practices and other guidance to their software developers which provides formatting requirements, commenting requirements, naming requirements, variable requirements, and the like, which are to be followed by the developers. In this case, the configuration file 123 generated by the AI model 122 may not adhere to the criteria/constraints set forth by the organization. That is, even though the AI model 122 may be trained on the best practices of an organization, the AI model may not generate a configuration file that matches all of the constraints of the best practices. This is referred to as “hallucinations”.

To prevent hallucinations from occurring within the configuration file 123, the filter may compare the content within the configuration file 123 to the constraints/requirements of the organization or other compliance authority which are stored in a constraints database 125 and determine whether or not the content within the configuration file 123 matches the constraints. The constraints may include indentation requirements, quotation mark requirements, ordering requirements, subnet address requirements, and the like. When the filter 124 determines that the configuration file 123 meets/matches the constraints, the filter may send a confirmation to the AI model 122 indicating the configuration file 123 is valid. In response, the AI model 122 may output the configuration file 123 to the GUI 114, enabling the user to access, download, and/or use the configuration file 123.

However, when the filter 124 determines that the configuration file 123 does not match one or more constraints, the filter 124 may send an identifier of the one or more constraints to the prompt generator 126. In this example, the prompt generator 126 may identify one or more prompts corresponding to the one or more constraints within a prompt database 127 and send the one or more prompts to the filter 124. The filter 124 may request a modification of the configuration file 123 by the AI model 122. Here, the filter 124 may provide the AI model 122 with the one or more prompts and a copy of the configuration file 123. In response, the AI model 122 may be executed on the configuration file 123 and the constraints (and possibly the initial query) and a modified configuration file may be generated. Here, the AI system may attempt to validate the modified configuration file. When the modified configuration file does not satisfy one or more constraints, the process may be repeated in an iterative loop until the modified configuration file meets all the constraints.

In one example of the instant solution, the pre-trained AI model 122 is subjected to a retraining process using a diverse set of proprietary datasets tailored to specific industries and application domains. This retraining process ensures that the AI model 122 can generate and validate configuration files across various use cases, such as cloud configurations, enterprise software deployments, and industry-specific applications. For example, the AI model 122 is retrained in cloud configurations using datasets comprising configuration files and best practices relevant to virtualized environments, container orchestration systems, and cloud-native applications. These datasets include data points on network configurations, security policies, and resource allocation strategies, enabling the AI model 122 to generate optimized configuration files that adhere to industry standards and organizational requirements.

Additionally, the retraining process involves fine-tuning the AI model 122 with datasets specific to enterprise software systems, including enterprise resource planning (ERP) and customer relationship management (CRM) platforms. The datasets used for fine-tuning include configuration files from various versions and custom implementations of these platforms, allowing the AI model 122 to learn the nuances of different enterprise environments. This fine-tuning enhances the AI model's ability to generate configuration files that are compliant with organizational policies and optimized for enterprise-level performance and scalability.

The retraining and fine-tuning process is further supported by leveraging datasets from specialized fields such as healthcare, finance, and telecommunications. These datasets provide the AI model 122 with domain-specific knowledge, enabling it to generate configuration files that meet these industries' stringent compliance and security standards. For example, the AI model 122 is fine-tuned in the healthcare industry using datasets containing configurations for electronic health record (EHR) systems, ensuring that the generated configuration files comply with healthcare regulations and standards, such as HIPAA. Similarly, in the finance sector, the AI model 122 is retrained using datasets that include configurations for trading platforms and financial databases, enabling it to generate files that meet the regulatory requirements of financial authorities.

In another example of the instant solution, the AI model 122 and the associated system are designed for deployment across various computing environments, including on-premises servers, cloud-based platforms, hybrid systems, and edge computing devices. This ensures that the system can be used in diverse infrastructure setups. When deployed on on-premises servers, the AI model 122 is integrated within a local data center environment, leveraging the computational resources of dedicated hardware to perform high-speed processing of configuration files. This setup is advantageous for organizations that require strict control over their data and computing infrastructure, such as financial institutions and government agencies. The AI model 122 operates in conjunction with existing enterprise software and databases, utilizing proprietary datasets stored within the on-premises infrastructure to generate and validate configuration files tailored to the organization's specific needs.

In cloud-based deployments, the AI model 122 is hosted on scalable cloud platforms, such as public, private, or hybrid clouds, where the AI model 122 benefits from the elasticity of cloud resources, scaling its computational power based on the workload demands. This cloud-based deployment enables the system to handle large volumes of configuration files in real time, making it ideal for organizations with fluctuating resource requirements or those managing complex, distributed applications across multiple regions. The AI model 122 accesses cloud-native datasets, which may be configurations for virtual machines, containers, and microservices. These datasets ensure that the generated configuration files are optimized for cloud environments.

For hybrid systems, the AI model 122 is deployed to bridge the gap between on-premises and cloud environments, allowing seamless data and workload management across both infrastructures. In this configuration, the AI model 122 can process configuration files locally on on-premises servers while leveraging cloud resources for additional computational power or storage as needed.

The system is designed to be deployed on edge computing devices, enabling the AI model 122 to operate in environments where real-time processing and low-latency responses are critical. For example, in industrial IoT settings, the AI model 122 can be deployed on edge devices at manufacturing sites, where it processes configuration files related to machine operations and sensor data in real time. The AI model 122 uses edge-specific datasets, which include configurations for local devices, network gateways, and data aggregation points, ensuring that the generated configuration files are optimized for the limited resources and unique constraints of edge environments.

In another example of the instant solution, the system is engineered to manage and validate configuration files against constraints, encompassing regulatory compliance, industry-specific standards, and custom organizational rules. This capability ensures the system is adaptable and reliable across diverse regulatory environments. The AI model 122 is configured to analyze configuration files by cross-referencing them with a database of regulatory requirements and industry-specific standards. This database may include up-to-date regulations and guidelines from various sectors such as healthcare, finance, telecommunications, and government. For example, the finance sector checks compliance with regulations such as the Sarbanes-Oxley Act (SOX) and Basel III, guaranteeing that the configuration files adhere to financial reporting and risk management standards.

The system supports the incorporation of custom organizational rules into the validation process. Organizations can input their proprietary standards and best practices into the constraints database 125, enabling the AI model 122 to tailor the validation process to their needs. For example, an enterprise with a unique security protocol can integrate its guidelines into the system, ensuring all generated configuration files are validated against these custom rules.

The system's validation process is designed to be iterative, allowing for continuous refinement of configuration files until they satisfy all relevant constraints. When a configuration file fails to meet one or more specified conditions, the AI model 122 generates prompts that guide the file's modification. This process is repeated, each iteration narrowing down discrepancies until the configuration file is fully compliant. This iterative validation approach ensures the final configuration file is error-free and reduces the risk of regulatory or compliance-related issues arising during system deployment.

In another example of the instant solution, the system is engineered to manage and validate configuration files against various constraints, encompassing regulatory compliance, industry-specific standards, and custom organizational rules. The AI model 122 is configured to analyze configuration files by cross-referencing them with a comprehensive database of regulatory requirements and industry-specific standards. The system supports incorporating custom organizational rules into the validation process to enhance its adaptability further. Organizations can input their proprietary standards and best practices into the constraints database 125, enabling the AI model 122 to tailor the validation process to their needs. For example, an enterprise with a unique security protocol can integrate its guidelines into the system, ensuring all generated configuration files are validated against these custom rules.

The system's validation process is designed to be iterative, allowing for continuous refinement of configuration files until they satisfy all relevant constraints. When a configuration file fails to meet one or more specified conditions, the AI model 122 generates prompts that guide the file's modification. This process is repeated, each iteration narrowing down discrepancies until the configuration file is fully compliant.

In another example of the instant solution, the system is designed for seamless integration into continuous integration and continuous deployment (CI/CD) pipelines, enhancing its practical utility in modern software development processes. Integrating the AI model 122 into CI/CD pipelines allows for the real-time validation and refinement of configuration files as part of the automated build and deployment processes. This capability ensures that configuration files are vetted for compliance and correctness before they are deployed into production environments, thereby reducing the likelihood of deployment errors and enhancing overall software delivery efficiency.

During the CI/CD process, the AI model 122 is invoked whenever a new configuration file is committed to the version control system. As part of the continuous integration phase, the AI model 122 retrieves the configuration file and validates it against the relevant constraints, which include organizational standards, security requirements, and environment-specific parameters. If discrepancies are detected, the AI model 122 initiates an iterative refinement process, as described further herein, to correct the errors before the file is passed along the pipeline.

The validated configuration files are deployed to the target environments in the continuous deployment phase. The system can handle diverse deployment scenarios, including rolling updates, canary releases, and blue-green deployments. The AI model 122 monitors and logs the performance of the deployed configuration files, providing feedback that can be used to fine-tune the system in subsequent iterations.

FIG. 1B illustrates a process 100B of an iterative loop 130 that may be performed by the AI system of FIG. 1A, according to examples and features of the instant solution, and FIG. 1C illustrates a termination of the process performed by the AI system of FIG. 1A, according to examples and features of the instant solution. Here, the filter 124 has two different options for possible execution including sending a request to the prompt generator 126 or sending a confirmation to the AI model 122.

In the example of FIG. 1B, the filter 124 determines that the configuration file 123 does not match at least one constraint of the organization or other authority. In response, the filter 124 triggers an iteration of the loop 130 which includes sending an identifier of the at least one constraint to the prompt generator 126. In response, the prompt generator determines at least one prompt and sends it to the filter 124. The filter 124 then queries the AI model 122 with the at least one prompt, the configuration file 123, the query, etc. and requests a modified configuration file.

In response, the AI model 122 may execute again on the configuration file 123, the at least one prompt, the query, and the existing configuration files in the configuration files database 128 to generate a modified configuration file (not shown). The modified configuration file may be checked by the filter 124. This process may be repeated until a modified configuration file generated by the AI model 122 matches or otherwise satisfies all of the constraints of the filter 124.

FIG. 1C illustrates a process 100C of confirming the validity of a configuration file according to examples and features of the instant solution. Referring to FIG. 1C, the filter 124 determines that the configuration file 123 (or a modified configuration file) matches the constraints within the constraints database 125. As such, the filter 124 may skip execution of the prompt generator 126 and instead provide a confirmation message to the AI model 122 indicating the configuration file 123 is valid. In response, the AI model 122 may output the configuration file 123 to the GUI 114. As another example, the software application 121 may deploy a system such as a software system at the host platform 120, and configure the system based on settings within the configuration file 123 generated by the AI model 122.

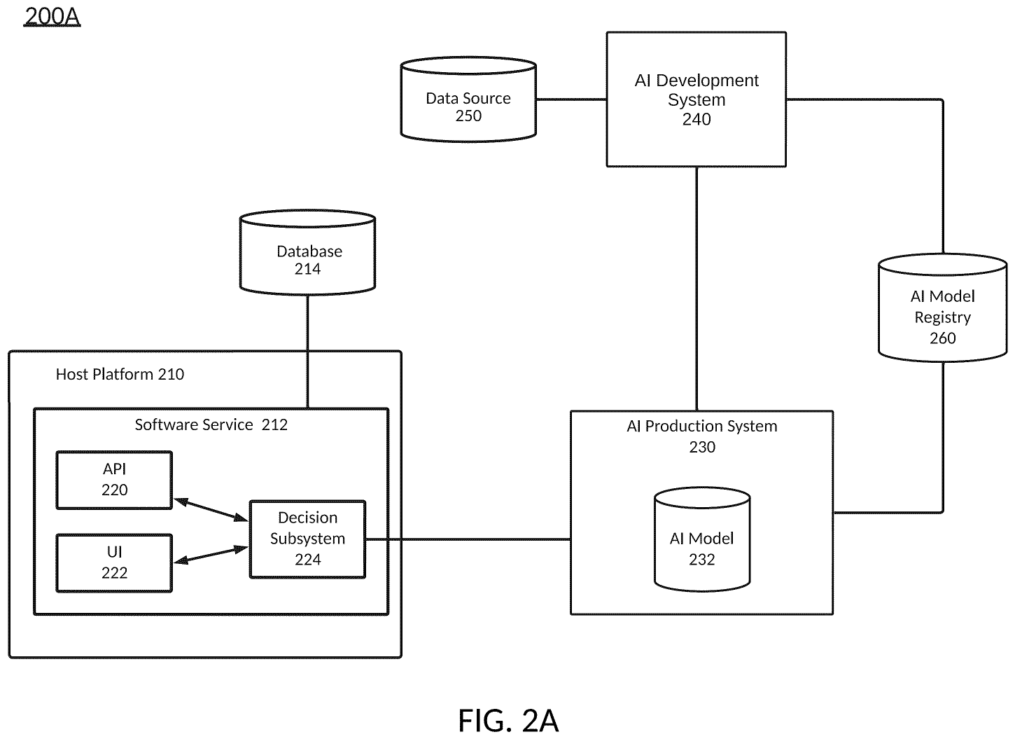

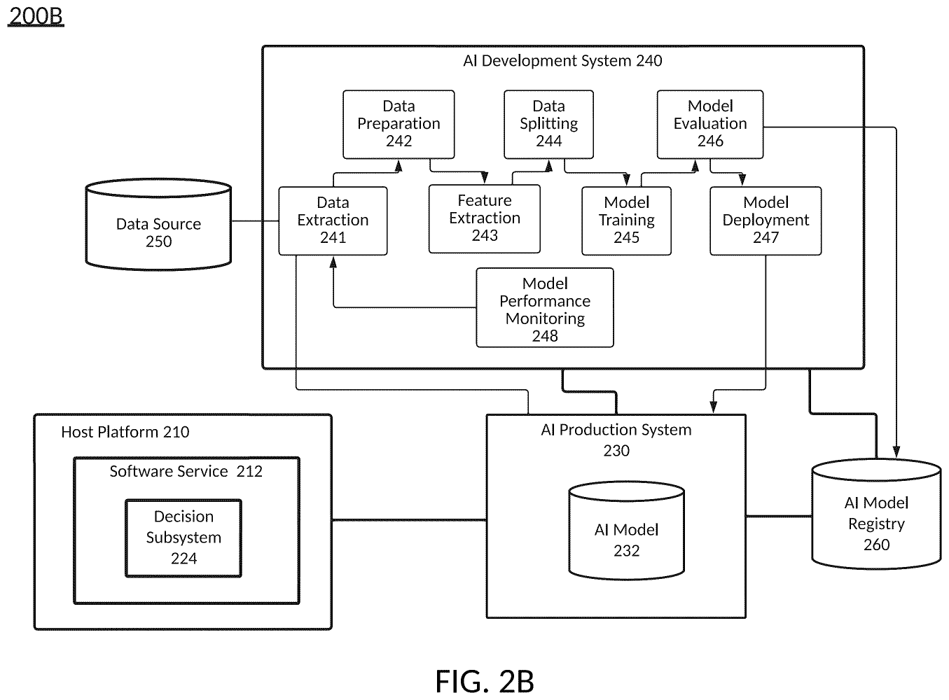

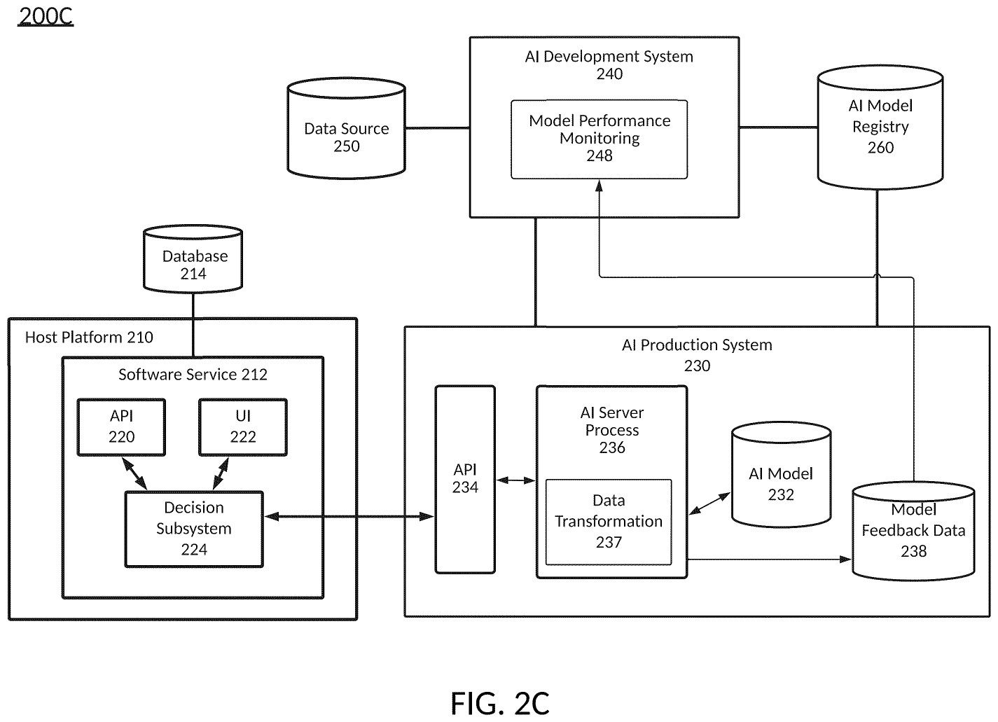

The AI model 122 described with respect to FIGS. 1A-1C may be a pre-trained AI model that is “fine-tuned” through additional training/retraining. For example, the pre-trained AI model may be trained using best practice documents and other documents of an organization by executing the pre-trained AI model on the best practice documents and other documents. As another example, the pre-trained AI model may be trained based on configuration files of an organization. Here, the pre-trained AI model may be executed on the configuration files of the organization to learn formatting and other standards followed by the organization. An example of the training process is described with respect to FIGS. 2A-2C.

Furthermore, AI model 122 depicted with respect to FIGS. 1A-1C may reside separately from the software application 121 which uses it, such as the process described with respect to FIGS. 2A-2C. AI model 122 may be an example of the AI model 232 described and depicted in FIGS. 2A-2C. Software application 121 may be an example of the software service 212 described and depicted in FIGS. 2A-2C. The AI model 122 may be deployed to an AI production system where the software application 121 may access and execute it.

FIG. 2A illustrates an AI network diagram 200A that supports AI-assisted decision points in a software service executing on a computer. One or more computing devices and a host platform 210 may communicate via a network. The host platform 210 may host a software service 212. The software service 212 may communicate with one or more databases 214 through a network during the course of service execution. In some examples and features of the instant solution, a computing device may host a service client which communicates with a corresponding software service 212.

A computing device may be a mobile phone, tablet, laptop computer, desktop computer, smartwatch, vehicle infotainment system, or any computing device including a processor and memory. The host platform 210 may include a single physical server, multiple physical servers, a cloud hosting environment, or a hybrid hosting environment in which some components of the host platform 210 are “on-premise” while others are cloud-hosted. The network is a computer network and may include one or more interconnected computer networks. For example, network may be or may include an Ethernet network, an asynchronous transfer mode (ATM) network, a wireless network, a telecommunications network or the like.

The software service 212 provides the service logic. It may provide one or more Application Programming Interfaces (APIs) for communicating with one or more service clients. A “thick” user interface client that runs on a computing device may utilize the APIs to communicate with the software service 212. Further, the software service 212 may provide hosted User Interfaces (UIs) that can be accessed through browser-based software on some computing devices.

The one or more service clients can enable service access for end users and may come in a variety of forms including, but not limited to, a mobile device application (“app”) or a web portal accessed via a browser on a computing device such as a laptop or desktop computer.

Detailed descriptions of the software architecture for offering different transactions and for dynamically offering products during an ongoing communication session in the instant solution are further described and depicted herein.

While the example instant solution shown utilizes a neural network such as a large language model (LLM), which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models such as LLMs, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

In the example of FIG. 2A, the software service 212 executing on host platform 210 may provide one or more application programming interfaces (APIs) 220 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 220 send data to one or more decision subsystems 224 of the software service 212 to assist in decision-making. In some examples and features of the instant solution, the software service 212 stores data included in API requests or data generated during processing the API requests into one or more databases 214.

Software service 212 may provide one or more user interfaces (UIs) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to one or more decision subsystems 224 of the software service 212 to assist with decision-making. In some examples and features of the instant solution, the software service 212 stores data included in UI requests or data generated during processing the UI requests into one or more databases 214.

Software service 212 may include one or more decision subsystems 224 that drive a decision-making process of the software service 212. In some examples and features of the instant solution, the decision subsystems 224 receive data from one or more APIs 220 as input into the decision-making process. In some examples and features of the instant solution, a decision subsystem 224 may receive data from one or more UIs 222 as input to the decision-making process. A decision subsystem 224 may gather service configuration or historical execution data from one or more databases 214 to aid in the decision-making process. A decision subsystem 224 may provide feedback to an API 220 or a UI 222.

An AI production system 230 may be used by a decision subsystem 224 in a software service 212 to assist in its decision-making process. The AI production system 230 includes one or more AI models 232 that are executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates one or more AI models 232. In some examples and features of the instant solution, the AI development system 240 utilizes data from one or more data sources 250 to develop and train one or more AI models 232. The data sources 250 may be local or third-party data sources. Further, the data provided by the data sources may be real-world or synthetic. In some examples and features of the instant solution, the AI development system 240 utilizes feedback data from one or more AI production systems 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained (or re-trained) and validated in the AI development system 240, it may be stored in an AI model registry 260 for retrieval by either the AI development system 240 or by one or more AI production systems 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing one or more AI models that support AI-assisted decision points. An AI development system 240 executes steps to develop an AI model 232 that begins with data extraction 241, in which data is loaded and ingested from one or more data sources 250. In some examples and features of the instant solution, historical model feedback data is extracted from one or more AI production systems 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 242 may be a manual process or an automated process using one or more of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using one or more of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set. These steps may be repeated with adjustments to one or more algorithm parameters until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step is used. In some examples and features of the instant solution, one or more unseen validation datasets are used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using one or more of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to one or more AI production systems 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes one or more triggers that result in the AI model 232 being updated by repeating steps 241-248 with updated data from one or more data sources 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 212 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 212, UI 222 data from software service 212 or data from other software service 212 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 212. In some examples and features of the instant solution, the response may result in an update to a UI 222 in software service 212. In some examples and features of the instant solution, the response includes a request identifier that can be used later by the software service 212 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

In some examples and features of the instant solution, the AI production system 230 includes a user interface (not shown). The user interface may be used to manage the production system infrastructure, the components of the production system, and the operation of the AI production system 230 and its components.

According to various examples and features of the instant solution, an artificial intelligence operational pipeline (e.g., an AI pipeline) may be used to train an artificial intelligence (AI) model by executing the AI model on training data. The AI pipeline may include various modules, nodes, etc. which perform various tasks of the AI pipeline. The tasks may be executed in sequence. As another example, the tasks may be executed in parallel. In addition to training an AI model, the AI pipeline may be used to perform an inference (e.g., generate a predictive output) by executing the AI model on input data.

According to various examples and features of the instant solution, the AI pipeline may validate the training data, the input data, the output data, and the like. For example, when the input data is determined to be invalid, the software may pause/stop the AI pipeline and flag a location (e.g., a point in the process, etc.) at which the process is stopped. Furthermore, the software may replace or otherwise fix the invalid data with valid data and resume the AI pipeline from the flagged location in the process.

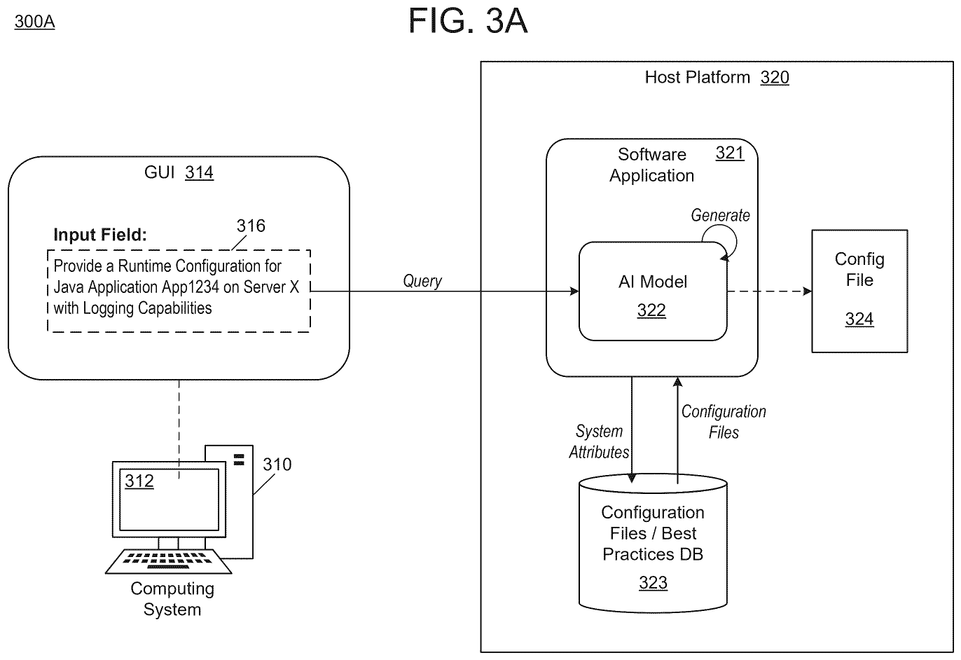

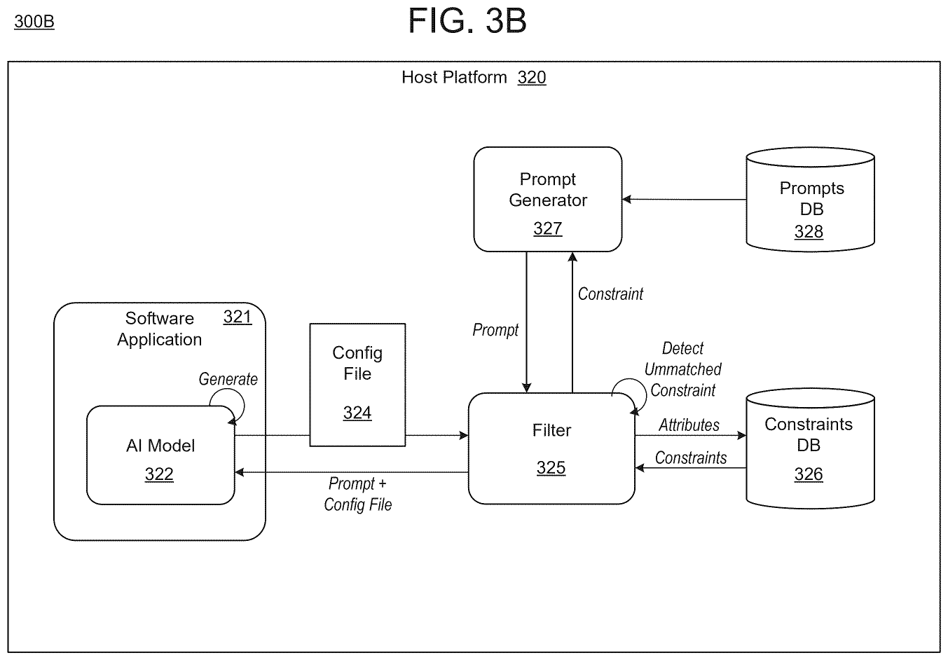

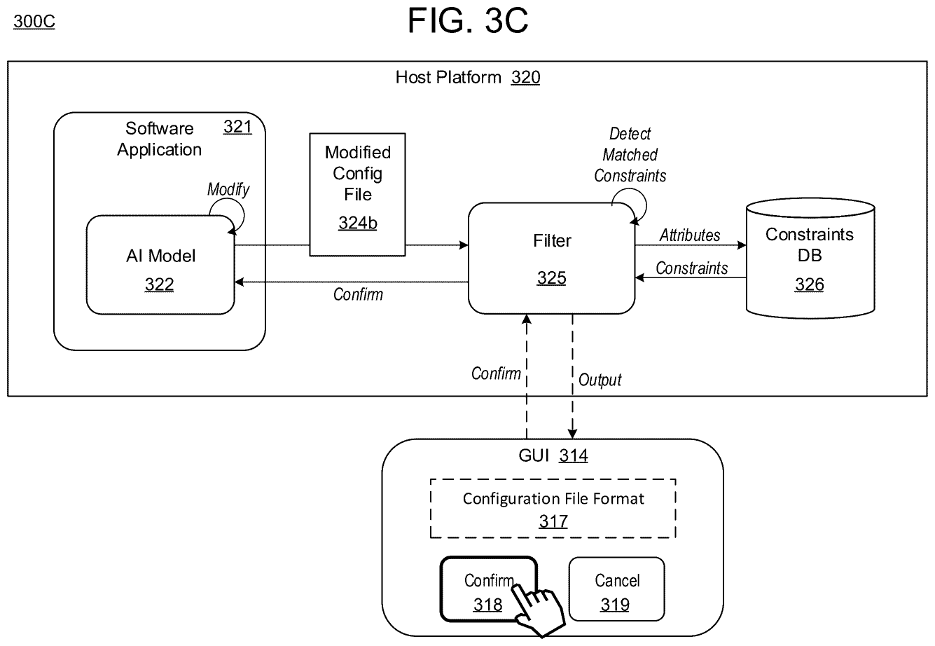

FIGS. 3A-3C illustrate a process of validating a configuration file using an AI system according to examples and features of the instant solution. For example, FIG. 3A illustrates a process 300A of generating a configuration file 324 based on a query received from a graphical user interface (i.e., GUI 314) of a software application according to examples and features of the instant solution. Referring to FIG. 3A, a host platform 320 may host a software application 321 capable of deploying software, infrastructure, and the like, for use by software systems. In some examples and features of the instant solution, the software application 321 may deploy other software programs (applications, services, APIs, etc.) within a production environment of the host platform 320.

According to various examples and features of the instant solution, the software application 321 includes an AI model 322 configured to generate configuration files. Here, the AI model 322 may include a trained AI model that is trained according to the examples shown and described with respect to FIGS. 2A-2C. As another example of the instant solution, the AI model 322 may be pre-trained AI model that may be fine-tuned using the training process shown and described in the examples of FIGS. 2A-2C.

Furthermore, AI model 322 depicted with respect to FIGS. 3A-3C may reside separately from the software application 321 which uses it, such as the process described with respect to FIGS. 2A-2C. AI model 322 may be an example of the AI model 232 described and depicted in FIGS. 2A-2C. Software application 321 may be an example of the software service 212 described and depicted in FIGS. 2A-2C. The AI model 322 may be deployed to an AI production system 230 where the software application 321 may access and execute it.

In this example, a computing system 310 may connect to the host platform 320 via a network and access the software application 321. In this example of the instant solution, the GUI 314 may be part of the software application 321 and may be displayed on a display screen 312 of the computing system 310. Here, a user may enter commands via the GUI 314. As an example, the user may enter a natural language query into an input box 316 displayed on the GUI 314. The natural language query may include a request for a particular type of configuration file. The natural language query may describe at least one of a type of software, a type of action, a type of service, a variable, a setting, or the like, that is to be included within a configuration file. The GUI 314 may extract the natural language input from the input box 316 and transmit the natural language input to the software application 321 on the host platform 320.

According to various examples and features of the instant solution, the AI model 322 may be a generative AI model such as an LLM, or the like. In response to receiving the query, the AI model 322 may generate a configuration file 324 that corresponds to the query. Here, the AI model 322 may ingest one or more of existing configuration files, best practice documents, and the like, from a configuration files/best practices database 323 as part of the input process. The AI model 322 may generate the configuration file 324 in a particular document or file type written in a common language for extensible markup, object notation, or the like.

FIG. 3B illustrates a process 300B of validating the configuration file 324 that is generated by the AI model 322 in FIG. 3A, according to examples and features of the instant solution. Referring to FIG. 3B, the software application 321 may provide the configuration file 324 to a filter 325. Here, the filter may be a software program that can identify attributes of the configuration file 324 such as a software program associated with the configuration file 324, an organizational standard associated with the configuration file 324, or the like, and retrieve constraints corresponding to the attributes from a constraints database 326. The filter 325 may compare the content within the configuration file 324 to the constraints pulled from the constraints database 326.

When the filter 325 detects at least one constraint that is not met by the configuration file 324, the filter 325 may transfer an identifier of the at least one constraint to a prompt generator 327. The at least one constraint may refer to a type of error that is detected, such as a missing quotation mark, improper indentation, improper commenting, improper network sub addresses, or the like. In response, the prompt generator 327 may generate at least one prompt based on the at least one constraint (type of error) and provide the at least one prompt to the filter 325. For example, the prompt generator 327 may identify one or more prompts within a prompts database 328 which correspond to the at least one constraint. Here, the filter 325 may transmit the at least one prompt and the configuration file 324 back to the AI model 322 for modification of the configuration file 324 based on the at least one prompt.

FIG. 3C illustrates a process 300C of the AI model 322 generating a modified configuration file 324b based on the at least one prompt provided in the example of FIG. 3B, according to the examples and features of the instant solution. Referring to FIG. 3C, the AI model 322 may perform another execution on the query, the configuration file 324, the at least one prompt, and the data from the configuration files/best practices database 323 and generate the modified configuration file 324b. In this case, the modified configuration file 324b may address the at least one constraint that is not met by the configuration file 324. Here, the same validation process performed by the filter 325 in FIG. 3B may be performed by the filter 325 on the modified configuration file 324b.

In this example, the modified configuration file 324b matches the constraints set forth in the constraints database 326. Accordingly, the filter 325 may determine that the modified configuration file 324b is finished, store the modified configuration file 324b, and provide a notification to the GUI 314 of the completion of the modified configuration file 324b. In this case, the user can review the configuration file format 317 or any other attributes capable of being analyzed and choose whether to accept (confirm) the modified configuration file 324b by pressing a GUI element to confirm 318 on the GUI 314. In response to the user pressing the GUI element to confirm 318, the modified configuration file 324b may be used to configure a software system. As another example, the user may decide to cancel the process by pressing a GUI element to cancel 319.

Although the use of the GUI 314 is shown in the example of FIG. 3C, it is to be appreciated that the filter 325 may not receive a command from the GUI 314 and may instead automatically launch the modified configuration file 324b and configure a software system based on the modified configuration file 324b.

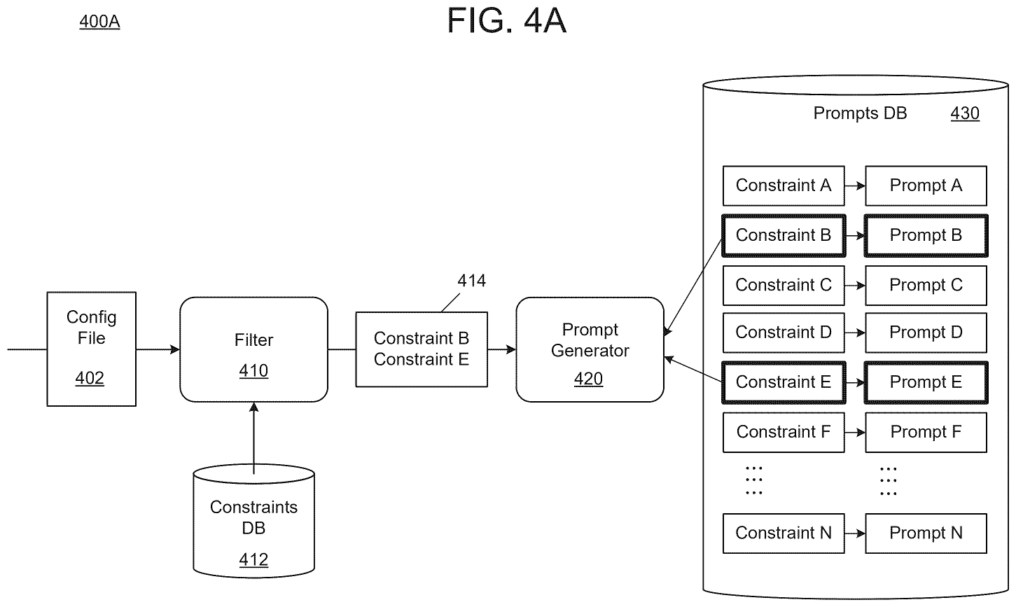

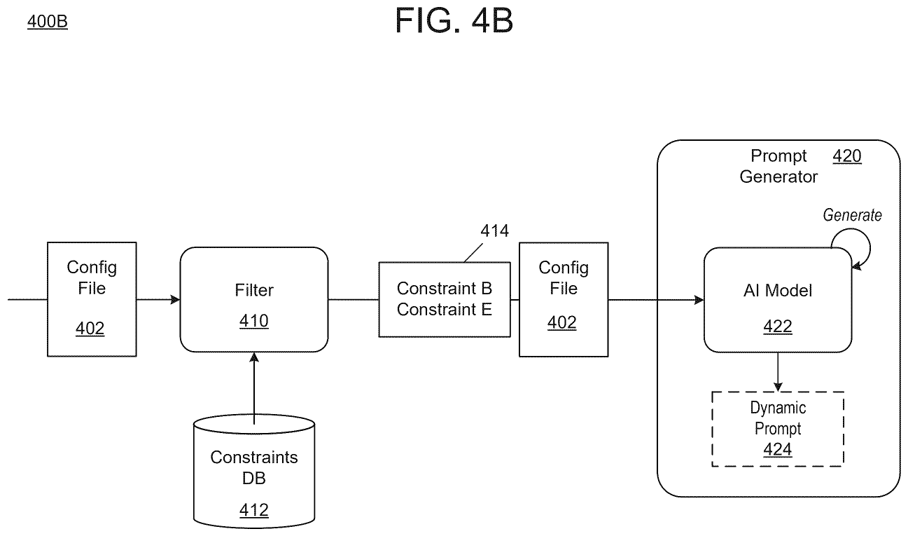

FIGS. 4A-4B illustrate a process of generating prompts for modifying a configuration file according to examples and features of the instant solution. For example, FIG. 4A illustrates a process 400A of generating a prompt based on prompts stored within a prompts database 430 according to examples and features of the instant solution. Referring to FIG. 4A, a filter 410 may receive a configuration file 402. For example, the filter 410 may correspond to the filter 325 in FIG. 3B, the filter 124 in FIG. 1A, and the like. In this example, the filter 410 may compare the configuration file 402 to a set of constraints stored within a constraints database 412. Here, the filter 410 determines that the configuration file 402 does not meet constraints 414.

According to various examples and features of the instant solution, the filter 410 may provide the constraints 414 to a prompt generator 420, such as the prompt generator 327 shown in the example of FIG. 3B, the prompt generator 126 shown in the example of FIG. 1A, and the like. In response, the prompt generator 420 may use identifiers of the constraints 414 to identify prompts within a prompts database 430. In this example, the constraints are mapped to prompts within the prompts database. When a constraint is not met, the prompt generator 420 may map the constraint to a prompt within the prompts database 430 and return the prompt to the filter 410. In the example of FIG. 4A, each constraint is mapped to a single prompt, however, multiple prompts may be mapped to a constraint, or the like.

FIG. 4B illustrates a process 400B of generating a prompt based on generative artificial intelligence according to examples and features of the instant solution. Referring to FIG. 4B, the filter 410 may detect that the configuration file 402 fails to meet the constraints 414 and may transmit an identifier of the constraints 414 and the configuration file 402 to an AI model 422. In this example, the AI model 422 may dynamically generate a prompt 424 based on the configuration file 402 and the constraints 414. In this case, the AI model 422 may be a generative model that is pre-trained to generate prompts or other text. As another example, the AI model 422 may be a trained AI model or a re-trained AI model. Here, the AI model 422 may be a different generative model than the AI model 322 shown in FIG. 3B, the AI model 122 shown in FIG. 1A, and the like.

Furthermore, AI model 422 depicted with respect to FIG. 4B may reside separately from the prompt generator 420 which uses it. AI model 422 may be an example of the AI model 232 described and depicted in FIGS. 2A-2C, and it may be deployed to an AI production system 230 where the prompt generator 420 may access and execute it.

The prompt generator examples shown in FIGS. 4A and 4B may be used on an iterative basis each time a new prompt is to be generated.

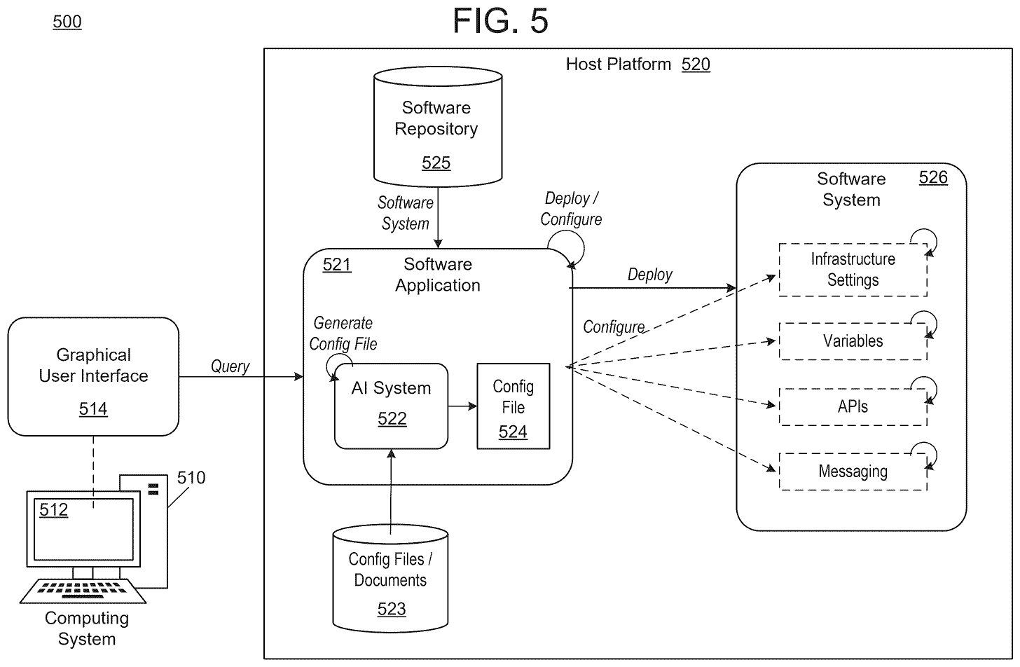

FIG. 5 illustrates a process 500 of deploying a software system 526 and configuring the software system 526 using a configuration files/documents database 523 according to examples and features of the instant solution. Referring to FIG. 5, a host platform 520, such as a cloud platform, web server, or the like, may host a software application 521. In this example, the software application 521 includes an AI model or AI system 522 configured to generate configuration files. The AI model or AI system 522 depicted with respect to FIG. 5 may reside separately from the software application 521 which uses it. AI model or AI system 522 may be an example of the AI model 232 described and depicted in FIGS. 2A-2C, and the software application 521 may be an example of the software service 212 described and depicted in FIGS. 2A-2C. The AI model or AI system 522 may be deployed to an AI production system 230 where the software application 521 may access and execute it.

A user may connect a computing system 510 to the host platform 520 over a network and gain access to the software application 521, for example, via a web browser, mobile application, or the like. In response, the software application 521 may display a graphical user interface 514 (e.g., GUI 514) on a display device 512 of the computing system 510. The GUI 514 may include input fields and mechanisms for submitting a natural language query to the software application 521.

In this example, the software application 521 receives a query from the GUI 514 and generates a configuration file 524 based on the query and based on existing configuration files, best practice documents, and the like, from a configuration files/documents database 523. In this example, the configuration file 524 may be validated, for example, based on the validation system shown in FIG. 1A, FIG. 3B, or the like. Upon validating the configuration file 524, the configuration file 524 can be used to configure the software system 526.

In the example of FIG. 5, the software application 521 may also receive a request to deploy the software system 526 into a production environment of the host platform 520. The request may be provided at the same time that the query for the configuration file is provided. As another example, the request may be provided after the query, or before the query. The software application 521 may retrieve an executable file (or files) of the software system from a software repository 525 and deploy the software system 526 via the host platform 520. Furthermore, at the same time (e.g., simultaneously), the software application 521 may configure one or more settings of the software system 526 based on the configuration file 524.

For example, the software application 521 may configure one or more of infrastructure settings, initial settings of the software system, environment variables, APIs, messaging, logging, storage paths, user interface preferences, plugins that are used, and the like, of the software system 526. Once configured, the software system 526 may be made accessible to users or otherwise accessible.

The instant solution involves several interconnected processes that ensure accurate validation and deployment of configuration files. Initially, configuration files are stored within a centralized database, providing an organized repository for all necessary files. Users interact with the system through a GUI, where they submit queries related to specific configuration files they wish to validate or deploy. When the solution receives a query, it activates an AI model that has been finetuned with proprietary data, which includes examples of configuration files, relevant documentation, and organizational standards. The AI model processes the configuration file, analyzing it against predefined constraints such as format standards, system requirements, and organizational policies. A responsive filter then validates the AI model's output. The filter checks whether the output satisfies all the predefined constraints, ensuring the accuracy and reliability of the responses. When the output does not meet the constraints, it is sent back to the AI model for further refinement. This recursive process continues until the output satisfies all conditions. Once the AI model's output meets the constraints, the solution proceeds to deploy the software system using the validated configuration file. The deployment involves applying the specified settings, which can include user interface configurations, network parameters, storage parameters, and operating system settings.

The instant solution incorporates a process of retraining a pre-trained AI model specifically on configuration files, their documentation, and relevant standards before executing the AI model on the actual configuration files and constraints. Initially, a pre-trained AI model, which has a general understanding of language and formatting principles, is selected as the foundation. The model undergoes a finetuning process using a curated dataset comprising examples of configuration files, detailed documentation associated with these files, and the specific standards and guidelines that the organization follows. During the finetuning phase, the AI model is exposed to various real-world examples of configuration files, enabling it to learn the nuances and specific requirements that these files are to meet. The documentation provides the model with contextual understanding, helping it to interpret the configuration files accurately. Standards and guidelines are also integrated into the training dataset to ensure the model comprehends the constraints and quality benchmarks that the configuration files are to adhere.

Once the model has been adequately retrained, it can execute more accurately on new configuration files. When a user submits a query via the GUI, the retrained AI model processes the configuration file, taking into account the constraints and standards learned during the fine-tuning process and ensuring the model's output aligns closely with the organization's specific requirements and reduces the likelihood of errors or non-compliance.

The instant solution handles instances where a configuration file does not satisfy one or more constraints. Initially, when a user submits a query via the GUI, the solution executes the AI model on the configuration file, assessing it against predefined constraints, such as formatting standards, system requirements, and organizational policies. When the AI model determines that the configuration file does not meet these constraints, it identifies the specific areas or parameters where the file fails to comply. When these deficiencies are identified, the solution automatically initiates a modification process. The AI model, utilizing its fine-tuned knowledge from prior training, suggests or makes the identified adjustments to the configuration file to address the unmet constraints based on the specific requirements and standards the configuration file is to adhere, ensuring that the changes are both relevant and precise. After the initial modification, the solution re-executes the AI model on the modified configuration file. The re-execution involves a reassessment of the file against all relevant constraints to verify that the adjustments have successfully brought the file into compliance. When the configuration file still does not satisfy all constraints, the solution continues this iterative process, making further modifications and re-evaluating the file until it fully complies with the standards.

The instant solution employs a methodical approach to ensure that configuration files are thoroughly validated and refined until they meet all defined constraints. Initially, when a user submits a query through the GUI, the solution's AI model processes the configuration file by analyzing it against predefined constraints, which include formatting standards, system requirements, and organizational policies. When the AI model determines that the configuration file does not satisfy these constraints, it identifies the specific areas of non-compliance. Upon identifying the non-compliance, the solution initiates a modification process. The AI model suggests or automatically makes changes to the configuration file to address the identified deficiencies. The modifications are informed by the AI model's finetuned knowledge, which includes understanding the organization's specific standards and the typical structure of configuration files, ensuring that the modifications are accurate and relevant to the constraints.

Once the initial modifications are made, the solution re-executes the AI model on the modified configuration file. The re-execution involves a detailed reassessment of the file against the same set of constraints. The purpose of this re-evaluation is to confirm that the modifications have successfully brought the file into compliance with the standards. When the modified configuration file still fails to meet all constraints, the solution continues the iterative process, wherein further adjustments are made, and the file is reassessed. The iteration between modification and re-evaluation continues until the AI model determines that the configuration file satisfies all constraints. This recursive validation and modification loop ensures that the final configuration file is fully compliant and free from errors.

The instant solution ensures that validated configuration files can be effectively applied to a second software application within the overall software system, covering a range of settings. Once the configuration files are validated through the AI model and responsive filtering process, the system proceeds to apply these settings to the second software application. This includes applying user interface (UI) settings, which dictate how the software presents information to users and how users interact with the software. Proper UI settings ensure a user-friendly and intuitive experience. The solution also applies network parameters specified in the configuration files. These parameters cover settings related to connectivity, data transfer protocols, and network security, ensuring that the software application can communicate effectively over the network while maintaining high standards of security and performance. Additionally, storage parameters are applied, involving configurations related to data management, such as file system settings, database connections, and data integrity protocols. These settings ensure efficient and secure handling of data by the software application, supporting its overall functionality and performance. Operating system settings are applied, which include configurations that affect how the software application interacts with the underlying operating system. These settings can involve process management, memory allocation, and system resource usage, ensuring that the application operates efficiently and optimally within the operating system environment.

The instant solution incorporates a process to ensure that the content or code within the configuration file adheres to predefined constraints. Initially, when a user submits a query through the GUI, the solution retrieves the relevant configuration file from the database. The AI model, which has been finetuned with proprietary data including examples of configuration files, documentation, and organizational standards, begins by executing an analysis on the content or code embedded within the configuration file. The AI model's analysis involves checking the content against a set of predefined constraints. These constraints can include formatting standards such as syntax rules, naming conventions, structure guidelines, and best practices for security and efficiency. The AI model utilizes its training to identify any deviations from these constraints, ensuring that the content is syntactically correct and also adheres to organizational and industry standards. When the content or code within the configuration file fails to meet any of these predefined constraints, the AI model highlights the specific areas of non-compliance. The solution then suggests or automatically makes identified adjustments to the content to bring it into compliance with the standards. The modification process is iterative; the AI model re-analyzes the adjusted content to verify that all constraints are now satisfied. When further adjustments are identified, the solution continues this cycle of modification and re-evaluation until the file fully adheres to the predefined formatting constraints.

The instant solution displays the results of the AI model's execution via the GUI and facilitates user interaction based on the results. Initially, the user submits a query through the GUI, prompting the solution to retrieve the relevant configuration file from the database. The AI model, which has been finetuned with proprietary data including configuration file examples, documentation, and organizational standards, analyzes the configuration file against predefined constraints such as formatting standards, system requirements, and organizational policies. Once the AI model completes its analysis, the results are displayed to the user through the GUI. The results include detailed information about the validation process, highlighting areas where the configuration file meets the constraints and identifying any non-compliance issues. The GUI presents the information in an accessible and user-friendly format, allowing users to easily understand the validation outcomes. The solution allows users to interact with the results by providing input via the GUI. For instance, when the AI model identifies areas of non-compliance, the user can review the suggested modifications and provide feedback or approve the changes directly through the interface. This interactive process ensures that users remain actively involved in the validation and refinement of the configuration files, enhancing the overall accuracy and reliability of the final output.

After incorporating user input, the solution may re-execute the AI model on the modified configuration file to ensure that all constraints are now satisfied. The updated results are again displayed via the GUI, providing users with real-time feedback on the status of the configuration file. Finally, once the configuration file meets all constraints and receives user approval, the solution proceeds with deploying the software system. The deployment process is conducted via a host platform, with the validated configuration settings applied to ensure proper operation.

In one example, the instant solution focuses on automating the validation of configuration files specifically for cloud-based applications. In this scenario, configuration files containing settings for cloud resources such as virtual machines, databases, and networking components are stored in a centralized database. Users interact with the solution through a web-based GUI, submitting queries to validate these configuration files before deployment. The AI model, finetuned with proprietary data, including cloud-specific configuration standards and best practices, analyzes the files against predefined constraints. The responsive filter ensures that the AI model's output adheres to organizational and industry standards. When the configuration file fails to meet any constraints, the AI model suggests modifications, which are iteratively refined until compliance is achieved. The solution then automatically applies the validated settings to the cloud infrastructure, ensuring seamless and error-free deployment.

In another example of the instant solution, the instant solution targets enterprise software systems, focusing on adaptive configuration management to handle the complexity and diversity of such environments. In this example of the instant solution, configuration files for various enterprise applications, including enterprise resource planning, customer relationship management, and custom in-house software, are maintained in a secure database. The solution provides an advanced GUI that allows information technology administrators to submit queries for validating these files. The AI model, trained with extensive data from enterprise software environments, evaluates the configuration files against a comprehensive set of constraints, including security protocols, performance benchmarks, and compliance requirements. The responsive filter iteratively refines the AI model's output, ensuring that validated and compliant configurations are deployed. Administrators can interact with the validation results via the GUI, providing inputs and approving the identified modifications. Once validated, the configuration settings are applied to the enterprise software systems, optimizing performance and ensuring compliance with organizational policies.

In another example, the instant solution integrates real-time configuration validation into DevOps pipelines, streamlining the continuous integration and continuous deployment (CI/CD) process. Configuration files for application environments, build scripts, and deployment settings are stored in a version-controlled repository. As developers commit changes, the solution automatically triggers the AI model to validate the updated configuration files. The AI model, trained with data from previous deployments and industry best practices, assesses the files against relevant constraints. The responsive filter checks the AI model's output, ensuring accuracy and compliance. When any issues are detected, the AI model suggests modifications, which are reviewed and approved by the development team via the integrated GUI. This real-time validation ensures that validated configurations proceed through the CI/CD pipeline, minimizing deployment failures and enhancing the overall reliability of the software delivery process.

The instant solution ensures that AI model outputs meet predefined conditions through a responsive filtering mechanism. When a user submits a query via a software application, the solution executes an AI model trained on relevant data to generate an initial formatted data structure. The data structure represents the AI model's response to the user's query and may include various elements such as formatted snippets, configuration files, or text-based outputs. The generated formatted data structure is subjected to a filtering process where it is evaluated against a set of predefined conditions. These conditions may encompass various criteria such as syntactical correctness, logical coherence, adherence to formatting standards, or specific organizational guidelines. When the filter determines that the formatted data structure does not satisfy any of the conditions, the solution identifies the specific conditions that were not met. For each failed condition, a corresponding prompt is identified. These prompts are designed to guide the AI model in modifying the data structure to address the identified issues. The solution re-executes the AI model using the original formatted data structure along with the identified prompts. This process generates a modified data structure aimed at rectifying the shortcomings identified by the filter. The prompts serve as additional context or constraints that help the AI model produce a more accurate and reliable output.

The modified formatted data structure is subjected to the filtering process again to determine when it now satisfies all the predefined conditions. This iterative process ensures continuous refinement of the data structure. When the modified data structure still fails to meet any conditions, the process of identifying prompts, re-executing the AI model, and reapplying the filter is repeated. The recursive loop continues until the data structure meets all the conditions, ensuring that the final output is accurate and reliable. Once the formatted data structure passes all the conditions, the validated and refined data structure is deployed via a host platform. This deployment ensures that the final output, now part of the software system, meets the standards and is ready for practical use.

The instant solution retrains a pre-trained AI model to enhance its performance on queries. The solution includes a pre-trained AI model that has been initially trained on a broad dataset. The model already has foundational knowledge and capabilities relevant to the general domain in which it will be applied. Proprietary data specific to the organization's domain is gathered, including formatted data structures, documentation, and standards. The data represents the specific requirements, practices, and conventions used within the organization. Examples include API documentation, configuration files, process guidelines, and best practice manuals. The solution prepares the collected proprietary data for training. This involves cleaning and formatting the data to ensure it is compatible with the AI model's training framework. Annotations and metadata may be added to highlight aspects and standards that the AI model is to learn. Once data has been collected, the pre-trained AI model is retrained using the prepared proprietary data. This fine-tuning process adjusts the model's parameters to align with the specific requirements and standards of the organization. The training process emphasizes learning the nuances of the organization's data structures, documentation, and standards, ensuring the model can generate outputs that adhere to these specificities. After fine-tuning, the solution validates the model's performance on a set of test queries representative of real-world applications. The testing phase includes various scenarios that the AI model will encounter, ensuring it can accurately generate data structures and responses that meet the predefined conditions.

The instant solution comprises checking the status of a toggle switch associated with the filter on a GUI of the software application and determining whether to execute the filter based on the status of the toggle switch. The solution includes a toggle switch control element integrated into a GUI for the software application. The toggle switch is prominently placed within the GUI and is configured to be easily accessible to users. The GUI provides a clear indication of the toggle switch's current state, such as “On” or “Off,” ensuring users are aware of whether the filter mechanism is active or inactive. The toggle switch implementation has two states: “On” and “Off.” The “On” state is configured to activate the filter mechanism, while the “Off” state is configured to bypass the filter. The toggle switch is responsive to user input and immediately reflects changes in its state. The solution connects the toggle switch status to the filter execution process. This involves creating a mechanism within the software application that continuously monitors the status of the toggle switch. When a query is submitted by the user, the solution first checks the toggle switch status before proceeding with any further processing. Conditional logic determines the execution path based on the toggle switch status. When the toggle switch is “On,” the solution proceeds to execute the filter on the AI-generated formatted data structure. The filter evaluates the data structure against predefined conditions to ensure it meets accuracy and reliability standards. When the toggle switch is “Off,” the solution bypasses the filter and directly returns the AI-generated output to the user without additional checks. The solution monitors the toggle switch status in real time. Event listeners or polling mechanisms are implemented to detect any changes in the toggle switch state and immediately update the solution's behavior accordingly.

The instant solution identifies prompts based on formatting errors within a formatted data structure and modifies the data structure accordingly. When a user submits a query via the software application, the AI model executes to generate a formatted data structure. The structure may include formatted snippets, configuration files, or other structured data relevant to the query. The generated formatted data structure is subjected to an initial filtering process. The filter evaluates the data structure against a set of predefined conditions, specifically focusing on formatting errors. These conditions include syntactical correctness, adherence to standards, and other formatting guidelines established by the organization. When the filter identifies that the formatted data structure does not satisfy one or more of the predefined conditions, it detects the specific formatting errors present. These errors may include incorrect indentation, improper use of whitespace, misaligned blocks, inconsistent naming conventions, or any other deviations from the specified formatting standards.

Upon detecting a formatting error, the solution identifies a prompt that corresponds to the specific type of error. The prompt is designed to guide the AI model in modifying the data structure to correct the identified formatting issue. The prompt provides explicit instructions or constraints related to the detected error, such as correcting indentation levels, aligning formatted blocks, or adjusting whitespace usage.

The instant solution identifies prompts based on the order of instructions within file and modifies the data structure accordingly. When a user submits a query via the software application, the AI model executes to generate a formatted data structure. The structure may include formatted snippets, scripts, or other instructional data relevant to the query. The generated formatted data structure is subjected to an initial filtering process. The filter evaluates the data structure against a set of predefined conditions, specifically focusing on the logical order of instructions. These conditions ensure that the sequence of instructions follows the logical and functional requirements set by the organization. When the filter identifies that the formatted data structure does not satisfy one or more of the predefined conditions related to the order of instructions, it detects the specific ordering errors present. These errors may include misplaced initialization steps, incorrect sequence of function calls, improper dependency handling, or any other deviations from the logical flow for correct execution. Upon detecting an ordering error, the solution identifies a prompt that corresponds to the specific type of error. The prompt is designed to guide the AI model in modifying the data structure to correct the identified ordering issue. The prompt provides explicit instructions or constraints related to the detected error, such as reordering function calls, adjusting the sequence of initialization steps, or correcting dependency sequences.

The instant solution is configured to determine that a formatted data structure does not satisfy a plurality of conditions, identify a plurality of corresponding prompts, and modify the data structure based on the execution of the AI model on these prompts. The solution processes a user query through an AI model to generate an initial formatted data structure. The data structure is subjected to a filtering process that evaluates it against multiple predefined conditions. These conditions may pertain to various aspects, such as syntactical correctness, logical order, formatting standards, and adherence to organizational guidelines. When the filter determines that the formatted data structure does not satisfy one or more of these conditions, it identifies the specific conditions that were not met. For each failed condition, a corresponding prompt is identified. These prompts are crafted to address the particular issues related to the failed conditions, providing explicit instructions or constraints that guide the AI model in modifying the data structure.

Once the relevant prompts are identified, the AI model is re-executed using the original formatted data structure along with the identified prompts. This execution generates a modified data structure aimed at rectifying the detected issues. The modified data structure is then re-evaluated by the filter to determine when the plurality of conditions is now satisfied. When the modified data structure still fails to meet any of the conditions, the process of identifying additional prompts and re-executing the AI model continues iteratively. This recursive refinement ensures that the data structure is progressively refined with each iteration, addressing multiple conditions simultaneously. The iterative process continues until the formatted data structure meets all the predefined conditions.

The instant solution generates a prompt by executing an LLM on a condition and the formatted data structure and using this prompt to modify the data structure. The solution submits a user query to the software application, which processes the query using an AI model to generate an initial formatted data structure. The data structure is subjected to a filtering process that evaluates it against predefined conditions such as syntactical correctness, logical coherence, and adherence to organizational standards. When the filter identifies that the formatted data structure fails to meet one or more conditions, it invokes an LLM to generate a prompt based on the specific condition and the context of the data structure. The prompt is generated by executing the LLM on the identified condition and the corresponding formatted data structure. The LLM analyzes the context and nuances of the condition, such as the nature of the error or deviation from the standard, and generates a relevant prompt. This prompt is designed to guide the AI model in making specific modifications to the data structure to address the identified issue. The generated prompt includes detailed instructions or constraints that directly target the condition that is to be corrected.

In one example, the instant solution is applied to correct formatting errors in AI-generated configuration snippets. When a user submits a query to generate a configuration snippet, the AI model processes the query and produces an initial formatted data structure. This structure is then evaluated against predefined formatting conditions, such as proper indentation, consistent naming conventions, and alignment of blocks. When the filter identifies any formatting errors, specific prompts are generated to address these errors. For instance, when the configuration snippet lacks proper indentation, a prompt instructing the AI model to adjust the indentation levels is generated. The AI model is re-executed with this prompt, resulting in a modified snippet that meets the predefined formatting standards. This iterative process continues until the configuration snippet is correctly formatted, ensuring that the final output adheres to the organization's formatting guidelines.

In another example, the instant solution verifies and corrects the logical order of instructions within AI-generated scripts. When a user queries the solution to generate a script, the AI model creates an initial formatted data structure comprising a sequence of instructions. The filtering process evaluates this structure against conditions related to the logical flow of instructions, such as the correct order of initialization steps, function calls, and dependencies. When the filter detects an ordering error, such as a function being called before its initialization, a prompt is generated to correct the sequence. The AI model is re-executed using this prompt to produce a modified script with the instructions in the correct order. This process is repeated iteratively until the script's logical flow is accurate, ensuring the script's functionality and reliability.

In another example, the instant solution ensures that AI-generated documents comply with specific formatting and content standards for regulatory compliance. When a user requests the generation of a compliance document, the AI model generates an initial formatted data structure. This structure is subjected to filtering against conditions such as mandatory sections, specific wording, and layout requirements. When the filter identifies any deviations from these standards, prompts are generated to correct the issues. For example, when a required section is missing, a prompt instructing the AI model to include the missing section is generated. The AI model re-executes with the prompt, resulting in a modified document that includes all determined sections and adheres to the regulatory standards. This iterative refinement process ensures that the final document is compliant with all relevant regulations and standards.

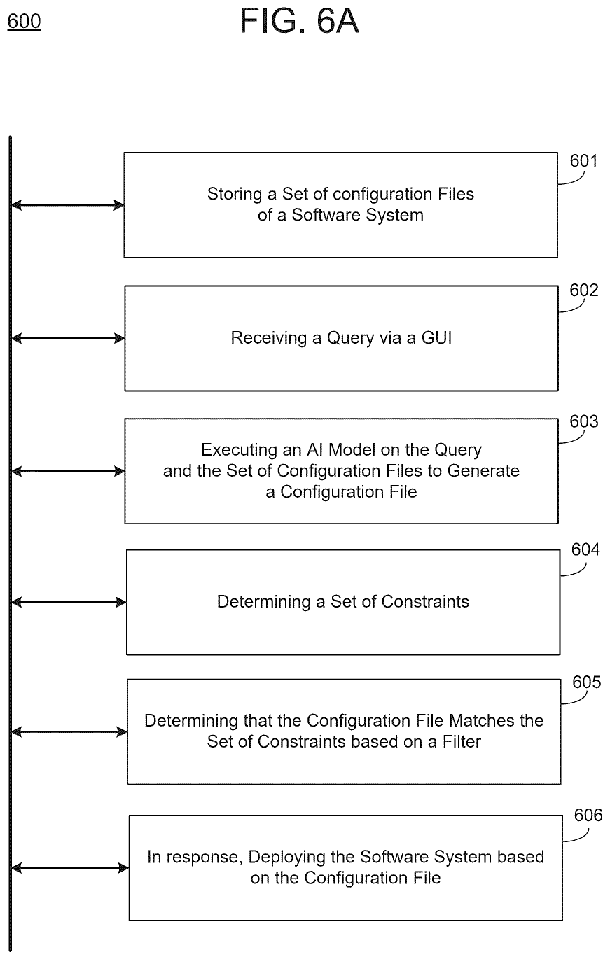

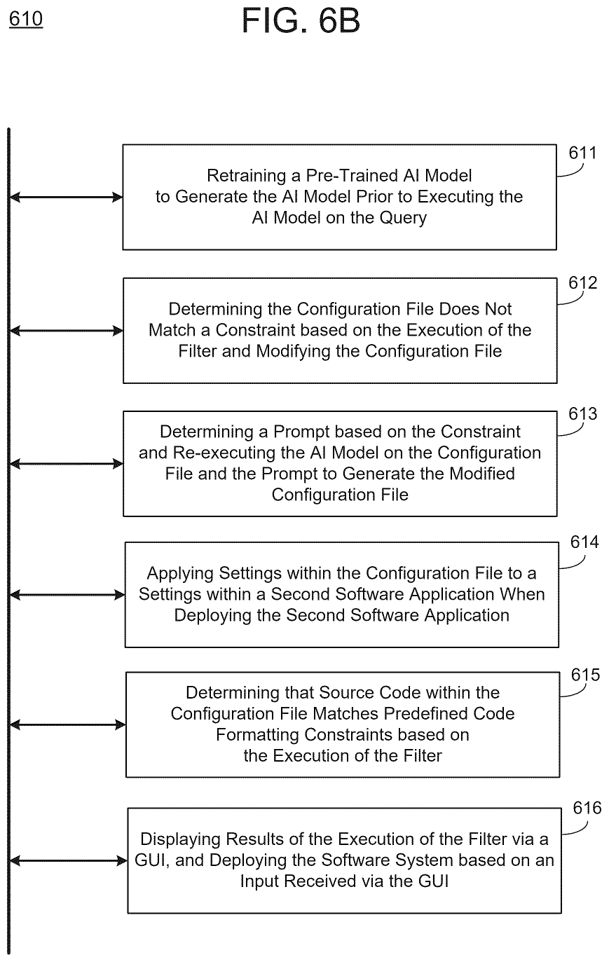

FIG. 6A illustrates a method 600 of generating and validating a configuration file according to examples and features of the instant solution. For example, the method 600 may be performed by at least one processor of a host platform such as a cloud platform, a web server, a software application, a combination of systems, and the like. Referring to FIG. 6A, in 601, the method may include storing a set of configuration files of a software system within a database. In 602, the method may include receiving a query associated with the software system via a graphical user interface (GUI) of a software application.

In 603, the method may include executing an artificial intelligence (AI) model on the query and the set of configuration files to generate a configuration file that matches the query. In 604, the method may include determining a set of constraints associated with at least one of the software system and the configuration file. In 605, the method may include determining that the configuration file matches the set of constraints based on execution of a filter on the configuration file and the set of constraints. In 606, in response to a determination that the configuration file matches the set of constraints, the method may include deploying the software system based on the configuration file.

FIG. 6B illustrates a method 610 of generating and validating a configuration file according to examples and features of the instant solution. For example, the method 610 may be performed by at least one processor of a host platform such as a cloud platform, a web server, a software application, a combination of systems, and the like. Referring to FIG. 6B, in 611, the method may further include retraining a pre-trained AI model on at least one of the configuration files, documentation of the configuration files, and standards of the configuration files to generate the AI model, prior to executing the AI model on the query. In 612, the method may further include determining that that the configuration file does not match a constraint based on the execution of the filter, and in response, modifying the configuration file based on the constraint.

In 613, the method may include determining a prompt based on the constraint, and re-executing the AI model on the configuration file and the prompt to generate a modified configuration file. In 614, the software system may include a second software application, and the method may include applying settings within the configuration file to one or more of user interface settings, network parameters, storage parameters, and operating system settings, of the second software application. In 615, the method may include determining that source code within the configuration file matches predefined code formatting constraints based on the execution of the filter. In 616, the method may further include displaying results of the execution of the filter via the GUI of the software application and receiving input via the GUI based on the results, wherein the deploying comprises deploying the software system via a host platform based on the input received via the GUI.

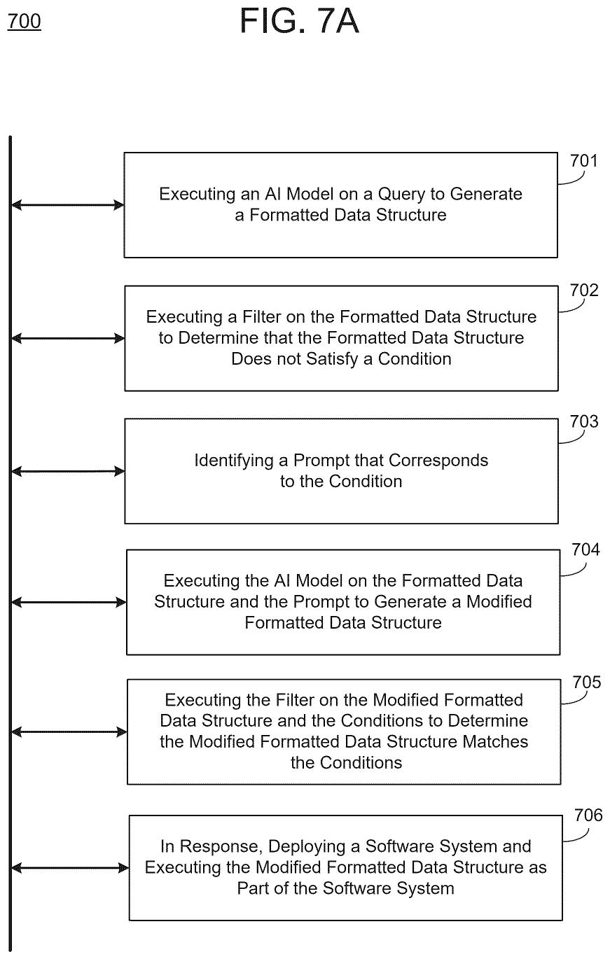

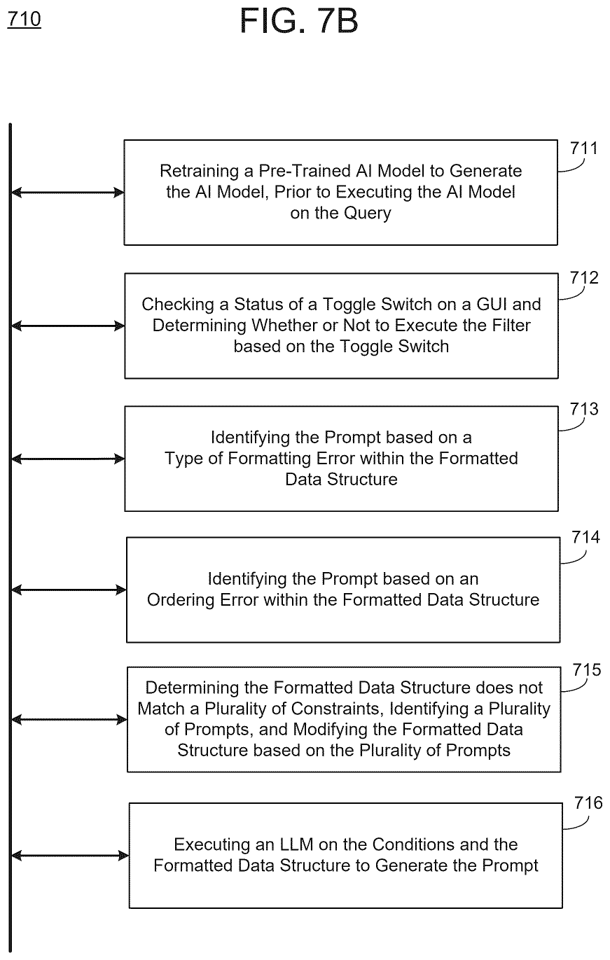

FIG. 7A illustrates a method 700 of generating and validating a configuration file according to examples and features of the instant solution. For example, the method 700 may be performed by at least one processor of a host platform such as a cloud platform, a web server, a software application, a combination of systems, and the like. Referring to FIG. 7A, in 701, the method may include executing an artificial intelligence (AI) model on a query via a software application to generate a formatted data structure. In 702, the method may include executing a filter on the formatted data structure and conditions of the formatted data structure to determine that the formatted data structure does not satisfy a condition from among the conditions.

In 703, the method may include identifying a prompt that corresponds to the condition. In 704, the method may include executing the AI model on the formatted data structure and the prompt to generate a modified formatted data structure. In 705, the method may include executing the filter on the modified formatted data structure and the conditions associated with the formatted data structure to determine that the modified formatted data structure matches the condition. In 706, in response, the method may include deploying a software system via a host platform and executing the modified formatted data structure as part of the software system.

FIG. 7B illustrates a method 710 of generating and validating a configuration file according to examples and features of the instant solution. For example, the method 710 may be performed by at least one processor of a host platform such as a cloud platform, a web server, a software application, a combination of systems, and the like. Referring to FIG. 7B, in 711, the method may further include retraining a pre-trained AI model on at least one of computer files, documentation of the computer files, and standards of the computer files to generate the AI model, prior to executing the AI model on the query. In 712, the method may further include checking a status of a toggle switch associated with the filter on a graphical user interface (GUI) of the software application, and determining whether or not to execute the filter based on the status of the toggle switch.

In 713, the conditions may correspond to code formatting errors, and the method may include identifying the prompt comprise identifying the prompt based on a type of formatting error within the formatted data structure. In 714, the conditions may correspond to an order of instructions within the formatted data structure, and the method may include identifying the prompt comprise identifying the prompt based on an ordering error within formatted data structure. In 715, the method may include determining that the formatted data structure does not match a plurality of constraints, identifying a plurality of prompts corresponding to the plurality of constraints, and modifying the formatted data structure based on execution of the AI model on the plurality of prompts. In 716, the method may include executing a large language model (LLM) on the conditions and the formatted data structure to generate the prompt.

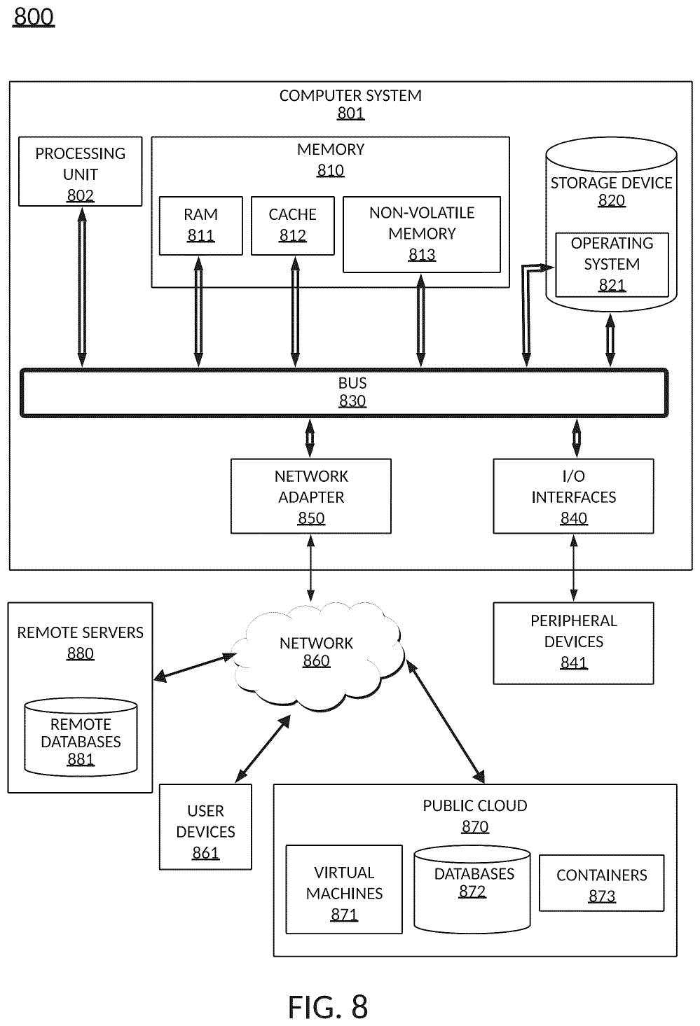

The examples and features of the instant solution may be implemented in one or more of the elements described or depicted herein, including for example, the elements described or depicted in FIG. 8. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 8 illustrates an example computer system architecture, which may represent or be integrated in any of the above-described components, etc.

FIG. 8 illustrates a computing environment according to the instant solution's example features, structures, or characteristics. FIG. 8 is not intended to suggest any limitation as to the scope of use or functionality of features, structures, or characteristics of the instant solution of the application described herein. Regardless, the computing environment 800 can be implemented to perform any of the functionalities described herein. In computing environment 800, there is a computer system 801, operational within numerous other general-purpose or special-purpose computing system environments or configurations.

Computer system 801 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 860 or querying a database. Depending upon the technology, the performance of a computer-implemented method may be distributed among multiple computers and among multiple locations. However, in this presentation of the computing environment 800, a detailed discussion is focused on a single computer, specifically computer system 801, to keep the presentation as simple as possible.

Computer system 801 may be located in a cloud, even though it is not shown in a cloud in FIG. 8. On the other hand, computer system 801 may not be in a cloud except to any extent as may be affirmatively indicated. Computer system 801 may be described in the general context of computer system-executable instructions, such as program modules, executed by a computer system 801. Generally, program modules may include routines, programs, objects, components, logic, data structures, and so on that perform tasks or implement certain abstract data types. As shown in FIG. 8, computer system 801 in computing environment 800 is shown in the form of a general-purpose computing device. The components of computer system 801 may include but are not limited to, at least one processor or processing unit 802, a system memory 810, and a bus 830 that couples various system components, including system memory 810 to processing unit 802.

Processing unit 802 includes at least one computer processor of any type now known or to be developed. The processing unit 802 may contain circuitry distributed over multiple integrated circuit chips. The processing unit 802 may also implement multiple processor threads and multiple processor cores. Cache 812 is a memory that may be in the processor chip package(s) or located “off-chip,” as depicted in FIG. 8. Cache 812 is typically used for data or code accessed by the threads or cores running on the processing unit 802. In some computing environments, processing unit 802 may be designed to work with qubits and perform quantum computing.

Memory 810 is any volatile memory now known or to be developed in the future. Examples include dynamic random-access memory (RAM) 811 or static type RAM 811. Typically, the volatile memory is characterized by random access, but this may not be the characterization unless affirmatively indicated. In computer system 801, memory 810 is in a single package. It is internal to computer system 801, but alternatively or additionally, the volatile memory may be distributed over multiple packages and/or located externally with respect to computer system 801. By way of example, memory 810 can be provided for reading from and writing to a non-removable, non-volatile magnetic media (shown as storage device 820, and typically called a “hard drive”). Memory 810 may include at least one program product having a set (e.g., at least one) of program modules configured to carry out the functions of various features, structures, or characteristics of the instant solution of the application. A typical computer system 801 may include cache 812, a specialized volatile memory generally faster than RAM 811 and generally located closer to the processing unit 802. Cache 812 stores frequently accessed data and instructions accessed by the processing unit 802 to speed up processing time. The computer system 801 may also include non-volatile memory 813 in the form of ROM, PROM, EEPROM, and flash memory. Non-volatile memory 813 often contains programming instructions for starting the computer, including the basic input/output system (BIOS) and information to start the operating system 821.

Computer system 801 may include a removable/non-removable, volatile/non-volatile computer storage device 820. For example, storage device 820 can be a non-removable, non-volatile magnetic media (not shown and typically called a “hard drive”). At least one data interface can connect it to the bus 830. In features, structures, or characteristics of the instant solution where computer system 801 has a large amount of storage (for example, where computer system 801 locally stores and manages a large database), then this storage may be provided by peripheral storage devices 820 designed for storing very large amounts of data, such as a storage area network (SAN) that is shared by multiple, geographically distributed computers.

The operating system 821 is software that manages computer system 801 hardware resources and provides common services for computer programs. Operating system 821 may take several forms, such as various known proprietary operating systems or open-source Portable Operating System Interface type operating systems that employ a kernel.

The bus 830 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 830 is the signal conduction path that allows the various components of computer system 801 to communicate.

Computer system 801 may communicate with at least one peripheral device, 841, via an input/output (I/O) interface, 840. Such devices may include a keyboard, a pointing device, a display, etc. ; at least one device that enables a user to interact with computer system 801; and/or any devices (e.g., network card, modem, etc.) that enable computer system 801 to communicate with at least one other computing devices. Such communication can occur via I/O interface 840. As depicted, I/O interface 840 communicates with the other components of computer system 801 via bus 830.

Network adapter 850 enables the computer system 801 to connect and communicate with at least one network 860, such as a local area network (LAN), a wide area network (WAN), and/or a public network (e.g., the Internet). It bridges the computer's internal bus 830 and the external network, exchanging data efficiently and reliably. The network adapter 850 may include hardware, such as modems or Wi-Fi signal transceivers, and software for packetizing and/or de-packetizing data for communication network transmission. Network adapter 850 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 860 is any computer network that can receive and/or transmit data. Network 860 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 860 may be replaced and/or supplemented by LANs designed to communicate data between devices in a local area, such as a Wi-Fi network. The network 860 typically includes computer hardware such as copper transmission cables, optical transmission fibers, wireless transmission, routers, firewalls, switches, gateway computers, edge servers, and network infrastructure known now or to be developed in the future. Computer system 801 connects to network 860 via network adapter 850 and bus 830.

User devices 861 are any computer systems used and controlled by an end user in connection with computer system 801. For example, in a hypothetical case where computer system 801 is designed to provide a recommendation to an end user, this recommendation may typically be communicated from network adapter 850 of computer system 801 through network 860 to a user device 861, allowing user device 861 to display, or otherwise present, the recommendation to an end user. User devices can be a wide array, including personal computers, laptops, tablets, hand-held, mobile phones, etc.

A public cloud 870 is an on-demand availability of computer system resources, including data storage and computing power, without direct active management by the user. Public clouds 870 are often distributed, with data centers in multiple locations for availability and performance. Computing resources on public clouds 870 are shared across multiple tenants through virtual computing environments comprising virtual machines 871, databases 872, containers 873, and other resources. A container 873 is an isolated, lightweight software for running a software application on the host operating system 821. Containers 873 are built on top of the host operating system's kernel and contain software applications and some lightweight operating system APIs and services. In contrast, virtual machine 871 is a software layer with an operating system 821 and kernel. Virtual machines 871 are built on top of a hypervisor emulation layer designed to abstract a host computer's hardware from the operating software environment. Public clouds 870 generally offers databases 872, abstracting high-level database management activities. At least one element described or depicted in FIG. 8 can perform at least one of the actions, functionalities, or features described or depicted herein.

Remote servers 880 are any computers that serve at least some data and/or functionality over a network 860, for example, WAN, a virtual private network (VPN), a private cloud, or via the Internet to computer system 801. These networks 860 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 880 can also host remote databases 881, with the database located on one remote server 880 or distributed across multiple remote servers 880. Remote databases 881 are accessible from database client applications installed locally on the remote server 880, other remote servers 880, user devices 861, or computer system 801 across a network 860. An AI/ML model described or depicted here may reside fully or partially on any of the elements described or depicted in FIG. 8.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

1. An apparatus comprising:
a memory; and
a processor configured to:
execute an artificial intelligence (AI) model on a query associated with a software application to generate a configuration file,
determine that the from configuration file contains an error in at least one of format, comments, names, order, and variables based on a filter,
identify a prompt that corresponds to the error,
execute the AI model on the configuration file and the prompt to generate a modified configuration file,
validate that the modified configuration file does not contain the error based on the filter, and
execute the validated modified configuration file and configure the software application based on content within the validated modified configuration file.

2. The apparatus of claim 1, wherein the processor is further configured to train a pre-trained AI model on at least one of computer files, documentation of the computer files, and standards of the computer files to generate the AI model, prior to execution of the AI model on the query.

3. The apparatus of claim 1, wherein the processor is further configured to check a status of a toggle switch associated with the filter on a graphical user interface (GUI), and determine whether or not to execute the filter based on the status of the toggle switch.

4. The apparatus of claim 1, wherein the error corresponds to code formatting errors, and the processor is configured to identify the prompt based on a type of formatting error within the configuration file.

5. The apparatus of claim 1, wherein the error corresponds to an order of instructions within the configuration file, and the processor is configured to identify the prompt based on an ordering error within the configuration file.

6. The apparatus of claim 1, wherein the processor is configured to determine that the configuration file does not match a plurality of constraints, identify a plurality of prompts corresponding to the plurality of constraints, and modify the configuration file based on execution of the AI model on the plurality of prompts.

7. The apparatus of claim 1, wherein the processor is configured to execute a large language model (LLM) on the error and the configuration file to generate the prompt.

8. A method comprising:
executing an artificial intelligence (AI) model on a query associated with a software application to generate a configuration file;
determining that the configuration file contains an error in at least one of format, comments, names, order, and variables based on a filter;
identifying a prompt that corresponds to the error;
executing the AI model on the configuration file and the prompt to generate a modified configuration file;
validating that the modified configuration file does not contain the error based on the filter; and
executing the validated modified configuration file and configure the software application based on content within the validated modified configuration file.

9. The method of claim 8, further comprising retraining a pre-trained AI model on at least one of computer files, documentation of the computer files, and standards of the computer files to generate the AI model, prior to executing the AI model on the query.

10. The method of claim 8, further comprising checking a status of a toggle switch associated with the filter on a graphical user interface (GUI), and determining whether or not to execute the filter based on the status of the toggle switch.

11. The method of claim 8, wherein the error corresponds to code formatting errors, and the identifying the prompt comprise identifying the prompt based on a type of formatting error within the configuration file.

12. The method of claim 8, wherein the error corresponds to an order of instructions within the configuration file, and the identifying the prompt comprise identifying the prompt based on an ordering error within the configuration file.

13. The method of claim 8, wherein the executing comprises determining that the configuration file does not match a plurality of constraints, the identifying comprises identifying a plurality of prompts corresponding to the plurality of constraints, and the modifying comprises modifying the configuration file based on execution of the AI model on the plurality of prompts.

14. The method of claim 8, wherein the identifying the prompt comprises executing a large language model (LLM) on the error and the configuration file to generate the prompt.

15. A computer-readable storage medium comprising instructions which when executed by a computer cause a processor to perform:
executing an artificial intelligence (AI) model on a query associated with a software application to generate a configuration file;
determining that the configuration file contains an error in at least one of format, comments, names, order, and variables based on a filter;
identifying a prompt that corresponds to the error;
executing the AI model on the configuration file and the prompt to generate a modified configuration file;
validating the modified configuration file does not contain the error based on the filter; and
executing the validated modified configuration file and configuring the software application based on content within the validated modified configuration file.

16. The computer-readable storage medium of claim 15, wherein the processor is further configured to perform retraining a pre-trained AI model on at least one of computer files, documentation of the computer files, and standards of the computer files to generate the AI model, prior to executing the AI model on the query.

17. (canceled)

18. The computer-readable storage medium of claim 15, wherein the error corresponds to code formatting errors, and the identifying the prompt comprise identifying the prompt based on a type of formatting error within the configuration file.

19. The computer-readable storage medium of claim 15, wherein the error corresponds to an order of instructions within the configuration file, and the identifying the prompt comprise identifying the prompt based on an ordering error within the configuration file.

20. The computer-readable storage medium of claim 15, wherein the executing comprises determining that the configuration file does not match a plurality of constraints, the identifying comprises identifying a plurality of prompts corresponding to the plurality of constraints, and the modifying comprises modifying the configuration file based on execution of the AI model on the plurality of prompts.

21. The apparatus of claim 1, wherein the processor is configured to modify settings within the software application based on instructions within the validated modified configuration file to generate a configured software application.
